(19) United States
(12) Patent Application Publication
(10) Pub. No.: US 2008/0271007 A1
(43) Pub. Date: Oct. 30, 2008

(54) SYSTEM AND METHOD FOR MANAGED TUXEDO WRAPPER FOR .NET APPLICATIONS

(75) Inventor: Yong Gou, Beijing (CN)

Correspondence Address: FLIESLER MEYER LLP, 650 CALIFORNIA STREET, 14TH FLOOR, SAN FRANCISCO, CA, 94108, US

(73) Assignee: BEA SYSTEMS, INC., San Jose, CA (US)

(21) Appl. No.: 11/742,438

(22) Filed: Apr. 30, 2007

(51) Int. Cl. G06F 9/44

(52) U.S. Cl. 717/163

(57) ABSTRACT

A system supports managed wrapping of Tuxedo functions for .NET applications, comprising Wrapper Interfaces and Wrapper Utilities. The Wrapper Interfaces that wrap around one or more Tuxedo functions used by a .NET application are operable to encapsulate the one or more unmanaged Tuxedo libraries and provide connectivity between the one or more unmanaged Tuxedo libraries and the .NET application. The Wrapper Utilities are operable to build .NET applications using the Wrapper Interfaces, wherein the .NET applications are operable to invoke the one or more unmanaged Tuxedo libraries through Wrapper Interfaces to run under Common Language Runtime (CLR).

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

This invention relates to the field of using Tuxedo functions for .NET applications.

### BACKGROUND

Tuxedo (Transactions for Unix, Extended for Distributed Operations) is a middleware platform widely used to manage distributed transaction processing in distributed computing environments. It is a proven platform for unlocking enterprise legacy applications and extending them to a services oriented architecture, while delivering unlimited scalability and standards-based interoperability.

.NET is the Microsoft Web services strategy to connect information, people, systems, and devices through software. Integrated across the Microsoft platform, .NET technology provides the ability to quickly build, deploy, manage, and use connected, security-enhanced solutions with Web services. .NET-connected solutions enable businesses to integrate their systems more rapidly and in a more agile manner and help them realize the promise of information anytime, anywhere, on any device.

.NET provides a managed code environment, where code developed with a language compiler that is targeted to the Common Language Runtime (CLR), which manages code and provides memory management, thread management and remoting. However, the existing Tuxedo libraries are unmanaged code, which cannot be easily called from managed code, such as from a .NET application directly.

### BRIEF DESCRIPTION OF THE DRAWINGS

FIG. 1 is an illustration of an exemplary framework of managed wrapper of Tuxedo functions for .NET applications in accordance with one embodiment of the present invention.

FIG. 2 is an illustration of an exemplary process of building a .Net client using Wrapper Utilities in accordance with one embodiment of the present invention.

FIG. 3 is a flow chart illustrating an exemplary managed wrapping process of Tuxedo functions for .NET applications in accordance with one embodiment of the invention.

FIG. 4 is an illustration of a detailed exemplary of managed wrapper of Tuxedo functions for .NET applications in accordance with one embodiment of the present invention.

FIG. 5 is an exemplary illustration of the typed buffer class hierarchy supported by the managed wrapper in accordance with one embodiment of the invention.

FIG. 6A is an exemplary C# Code for connecting to a Single Context Client in accordance with one embodiment of the present invention.

FIG. 6B is an exemplary C# Code for connecting to a Multi-Context Client in accordance with one embodiment of the present invention.

### DETAILED DESCRIPTION

The invention is illustrated by way of example and not by way of limitation in the figures of the accompanying drawings in which like references indicate similar elements. It should be noted that references to “an” or “one” or “some” embodiment(s) in this disclosure are not necessarily to the same embodiment, and such references mean at least one.

The description of the invention as following uses the .NET environment as an example for a managed code environment and Tuxedo functions or libraries as an example for unmanaged distributed transaction functions or libraries. It will be apparent to those skilled in the art that other types of managed code environment and unmanaged distributed transaction functions or libraries can be used without limitation.

Various embodiments of the present invention can enable a managed code environment such as CLR of .NET to call unmanaged code, such as a function of Tuxedo by wrapping the unmanaged functions (classes) with a managed wrapper, which encapsulates the unmanaged function of Tuxedo. The managed wrapper can enable writing .NET applications using .NET programming languages to access Tuxedo services by informing CLR of the name of the function to be called, the name of the Dynamically Linked Library (DLL) that contains the function (libws.dll) and how to marshal the function's parameters (which can be input, output and input/output parameters). The managed wrapper class can be coded with proxy methods (wrapper interfaces) that mirror the underlying Tuxedo functions and convert between the managed and unmanaged data types. It also provides connectivity between .NET applications and Tuxedo services.

With such a managed wrapper, Microsoft .NET developers can create (workstation) clients in any programming languages targeting .NET CLR by accessing Tuxedo services. Besides providing a set of Object Oriented (OO) interfaces to .NET programmers, the .NET assembly can allow .NET developers to design and write code in OO styles. The .NET assembly can also leverage the benefit of .NET Framework and can be used with many .NET programming languages, which can be but are not limited to, C#, J#, VB .NET, and ASP.NET. For Tuxedo programmers, the managed wrapper can inherit most function invocation behavior in Tuxedo, which makes it easier for them to understand and use .NET Client classes to write applications.

In some embodiments, a certain class of Tuxedo functions, such as ATMI API's, can be implemented in a .NET programming language, which can be but is not limited to C#, in order to help .NET user to use C# to access Tuxedo services. C# is an object-oriented programming language developed by Microsoft as part of its .NET framework. It has a procedural, object-oriented syntax based on C++ that includes aspects of several other programming languages (most notably Java) with a particular emphasis on simplification—fewer symbolic requirements than C++, fewer declarative requirements than Java.

Managed Wrapper Framework

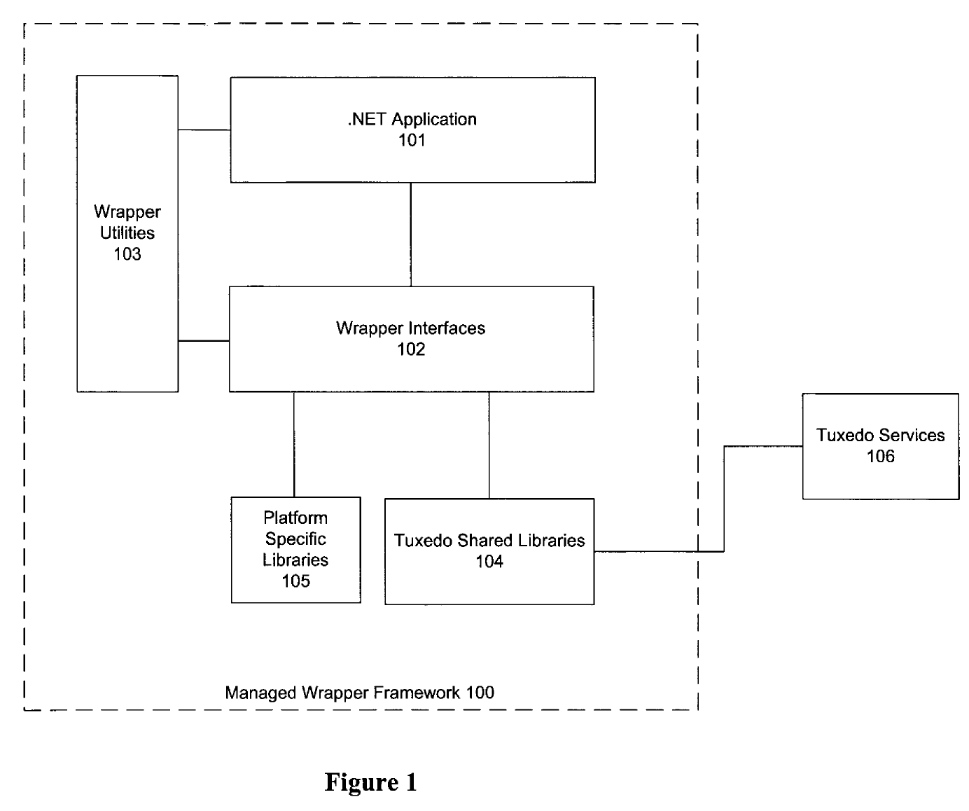

FIG. 1 is an illustration of an exemplary framework of managed wrapper 100 of Tuxedo functions for .NET applications in accordance with one embodiment of the present invention. As shown in FIG. 1, managed Wrapper Interfaces 102 can work as an intermediate layer connecting between a .NET application 101 and one or more underlying Tuxedo shared libraries 104 and Platform specific libraries 105. Wrapper Interfaces 102 can encapsulate the one or more Tuxedo shared libraries 104 and Platform specific libraries 105. These libraries can implement Tuxedo functions that the .NET application uses, where the functions can be OS platform specific, including any platform other than the Microsoft Windows family that .NET framework may be ported to. Note that some of these Tuxedo libraries can also be shared by any Tuxedo service 106. A .NET Assembly provided by Wrapper Interfaces 102 can contain interface (API) classes for the wrapper. Wrapper Interfaces 102 can also implement a set of object-oriented-styled interfaces that mirror the underlying one or more unmanaged Tuxedo libraries and convert between managed (.NET) and unmanaged (Tuxedo) data types. Wrapper Interfaces 102 can target the CLR environment of .NET, and can be invoked by the .NET application, client executables, and libraries at runtime. On the other hand, Wrapper Utilities 103 can reference the .Net assembly in order to build the .NET application 101 in .NET programming languages.

One embodiment of the present invention is a system to support managed wrapping of Tuxedo functions for .NET applications 100 that comprises Wrapper Interfaces 102 and Wrapper Utilities 103. The Wrapper Interfaces 102 that wrap around one or more Tuxedo functions used by a .NET application 101 can both encapsulate the one or more unmanaged Tuxedo libraries 104 and provide connectivity between the one or more unmanaged Tuxedo libraries 104 and the .NET application 101. The Wrapper Utilities 103 can build .NET applications using the Wrapper Interfaces, wherein the .NET applications can invoke the Tuxedo libraries through Wrapper Interfaces to run under Common Language Runtime (CLR).

In accordance with one embodiment of the present invention, the Wrapper Interfaces 102 can be object-oriented-styled. In addition, the Wrapper Interfaces 102 can be contained in one or more .Net Assembly libraries.

In accordance with one embodiment of the present invention, the Wrapper Interfaces 102 can mirror the underlying one or more unmanaged Tuxedo libraries 104 and convert between managed and unmanaged data types. In accordance with one embodiment of the present invention, the Wrapper Interfaces 102 can wrap around Tuxedo ATMI functions and FML functions.

In accordance with one embodiment of the present invention, the Wrapper Interfaces 102 can inform the .NET application 101 one ore more of: the name of a Tuxedo function to be called; name of Dynamically Linked Library (DLL) that contains the function; and how to marshal the function's one or more parameters.

In addition, in accordance with one embodiment of the present invention, the Wrapper Interfaces 102 can support typed buffer and application context, both of which will be discussed in later sections. The Wrapper Interfaces 102 can further encapsulate multiple sets of transaction functions supported by Tuxedo. The Wrapper Interfaces 102 can also encapsulate a composite data structure provided by Tuxedo for the use of high precision computation. In accordance with one embodiment of the present invention, the Wrapper Interfaces 102 can adopt exception as the basic error handling mechanism.

In accordance with yet another embodiment of the present invention, the Wrapper Utilities 103 can build the .NET applications by referencing the Wrapper Interfaces 102 at runtime.

Complex Data Type/High Precision Computation

In some embodiments, the managed wrapper can encapsulate the data structure of dec_t and related functions for it into a wrapper class named Dec_t to support it in the .NET wrapper classes so as to make users feel natural and convenient to use it just like they usually do in the ATMI C programming, due to the possible use of dec_t with the typed buffer of FML/FML32 and VIEW/VIEW32. Here, dec_t can be a composite data type provided by Tuxedo system for the use of high precision computation usually required by financial applications. To support it, Tuxedo can supply a set of special functions additionally for it to carry out the actual computation such as addition, subtraction, multiplication, division, conversion etc.

Wrapper Utility Classes

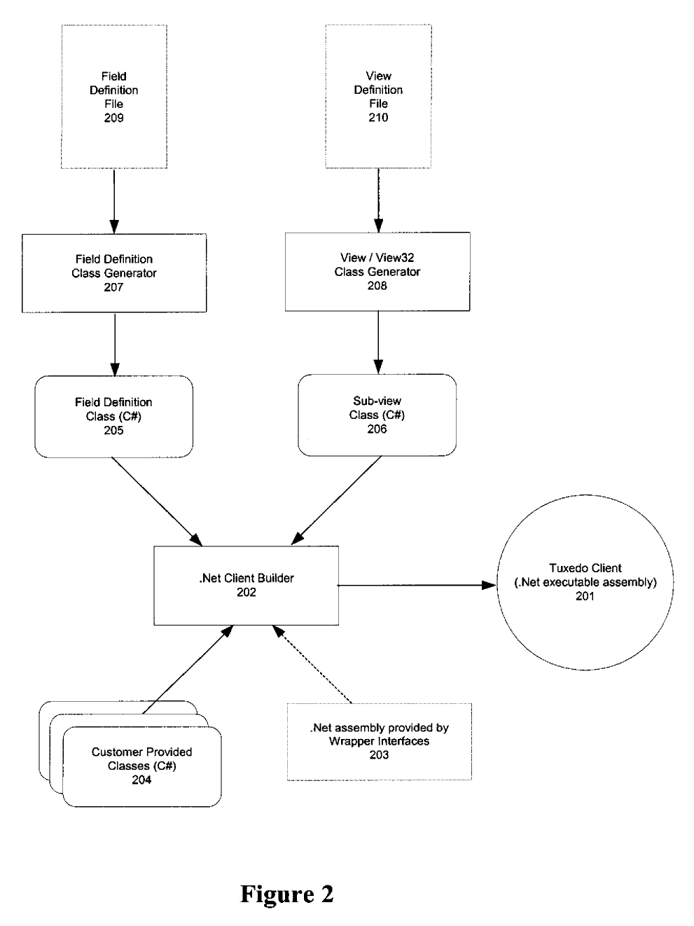

FIG. 2 is an illustration of an exemplary process of building a .Net client using Wrapper Utilities 103 in accordance with one embodiment of the present invention. In accordance with one embodiment of the present invention, the Wrapper Utilities 103 can include one or more of .Net client builder 202; View/View32 class generator 208 from input View description file 210; and Field Definition class generator 207 from input Field definition file 209.

As shown in FIG. 2, a Tuxedo .Net Client 201 can be generated by a .Net client builder 202 in accordance with one embodiment of present invention. The .Net client builder 202 can take, in C# source files, Field definition classes 205 generated by Field definition class generator 207, Sub-view classes 206 generated by View/View32 class generator 208, and other customer provided classes 204. In addition, in the process of generating a .Net client 201, the .Net client builder can use the .Net assembly provided by Wrapper Interfaces 203.

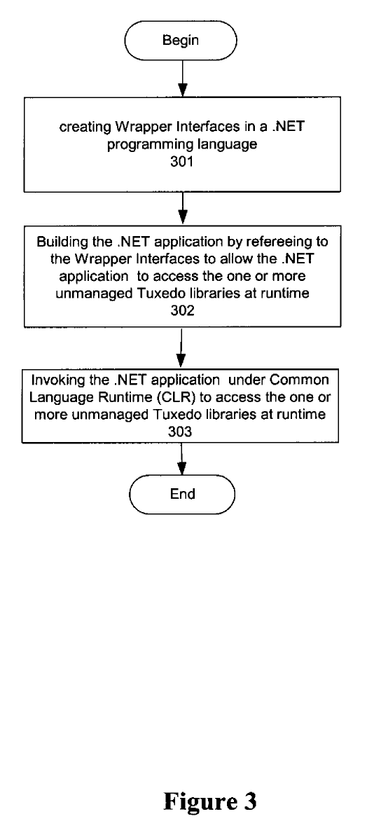

FIG. 3 is a flow chart illustrating an exemplary managed wrapping process of Tuxedo functions for .NET applications in accordance with one embodiment of the invention. As shown in FIG. 3, a set of object-oriented-styled interfaces that wrap around unmanaged Tuxedo libraries/functions can be defined and implemented at step 301. A .NET application can be built by referring to the Wrapper Interfaces to allow the .NET application to access the one or more unmanaged Tuxedo libraries at runtime at step 302. At step 303, a .NET application can then invoke the managed wrapper under CLR to access Tuxedo services at runtime.

One embodiment of the present invention is a method to support managed wrapping of Tuxedo functions for .NET applications that comprises: creating Wrapper Interfaces 102 in a .NET programming language and building the .NET application 101 by referring to the Wrapper Interfaces 102 to allow the .NET application 101 to access the one or more unmanaged Tuxedo libraries 104 at runtime. Here, the Wrapper Interfaces 102 can encapsulate one or more unmanaged Tuxedo libraries 104 and provide connectivity between the one or more unmanaged Tuxedo libraries 104 and a .NET application 101.

In addition, one embodiment of the present invention can comprise further step of invoking the .NET Wrapper 102 under Common Language Runtime (CLR) to access the one or more unmanaged Tuxedo libraries 104 at runtime.

.Net Managed Wrapper Interfaces

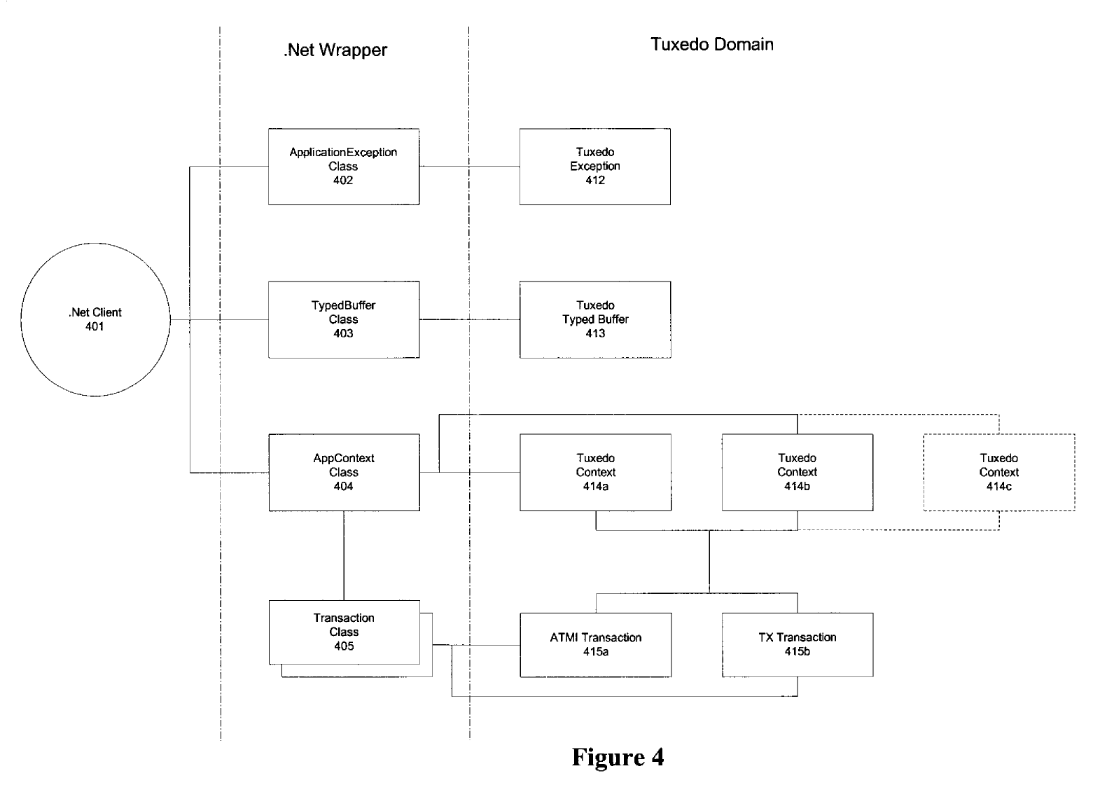

FIG. 4 is an illustration of a detailed exemplary of managed wrapper 102 of Tuxedo functions for .NET applications in accordance with one embodiment of the present invention.

One embodiment of the present invention is a system to support managed wrapping of Tuxedo functions for .NET applications that comprises an abstract interface to manipulate Tuxedo messages without the need to consider implementation details of the Tuxedo messages and an application environment descriptor representing a Tuxedo application environment.

Typed Buffer

In accordance with one embodiment of the present invention, the abstract interface to manipulate Tuxedo messages can support TypedBuffer 403.

In some embodiments, TypedBuffer 403 can be used in Tuxedo for message handling. TypedBuffer 403 provides an abstract interface for users to manipulate messages so that users do not need to consider its underlying details such as buffer initialization, data conversion and data-dependent routing when they design programs using it.

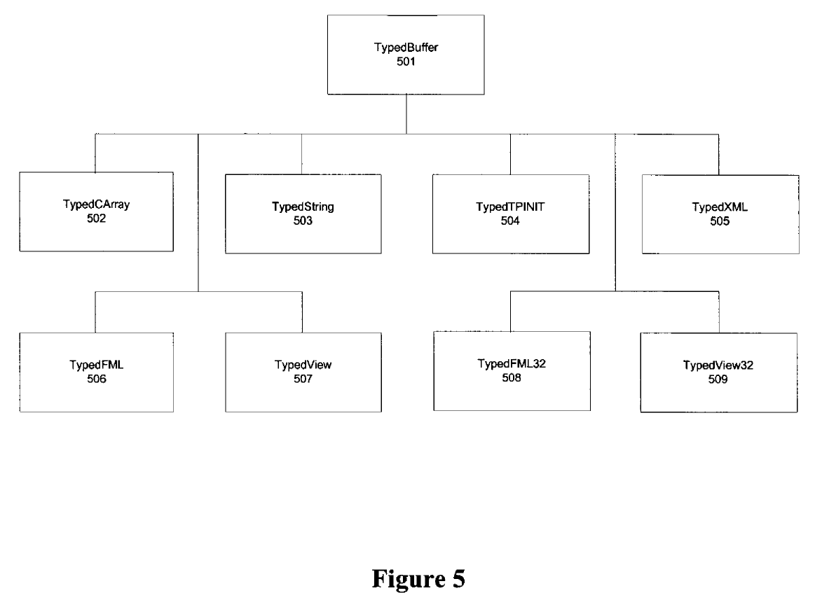

FIG. 5 is an exemplary illustration of the typed buffer class hierarchy supported by the managed wrapper in accordance with one embodiment of the invention. The buffer types supported by the managed wrapper include but are not limited to, FML, FML32, VIEW, VIEW32, CARRAY, and STRING.

In some embodiments, the wrapper class TypedBuffer 501 is the base class of all concrete Tuxedo buffer types 502-509 and provides some low level functions to all derived classes. Class TypedBuffer 501 is an abstract class and cannot be used to create instances directly. TypedBuffer 501 can encapsulate the pointer to a typed buffer inside and keep it private. Since users are unable to access the pointer directly, additional access control can be taken to do more checking to assure its safety. Three read only properties Length, Type and Subtype can be provided for users to get the length, type and subtype of the actual typed buffer. All ATMI and FML/FML32 functions which have pointers to typed buffers as their parameters or return values can get type of those parameters and return values changed from C type void*, char* FBFR* and FBFR32* to .NET type TypedBuffer 501 when they are wrapped in C# classes.

In some embodiments, users can create an instance of a concrete sub-class of TypedBuffer 501 with an expected buffer length passed instead of allocating a typed buffer by invoking an ATMI function. For a non-limiting example:

TypedBuffer data=new TypedCArray(1234);

Public member method Resize can be used to reallocate a typed buffer with a different buffer size, and users are able to redefine the size of an allocated typed buffer like:

data.Resize(2000); // data is a pre-allocated Carray typed buffer instance.

In addition, TypedBuffer 501 can provide a public member method Dispose for users to explicitly free the typed buffer they allocated, which is also invoked automatically by the .NET framework for a wrapper instance to implicitly free its allocated typed buffer before it is garbage collected.
TypdBuffer class 501 can also provide two overridable methods for its derived classes—PreSend and PostReceive, which can give the derived classes opportunities to do additional data conversion. Presend can be called for its actual containing classes by the wrapper code just before a typed buffer is going to be sent, and PostReceive can be called for its actual containing classes just after a typed buffer is received.

In some embodiments, the managed wrapper can use typed buffer classes TypedFML 506 and TypedFML32 508 to define FML functions, which are C language functions for defining and manipulating storage structures called fielded buffers, that contain attribute-value pairs called fields. Here, TypedFML 506 and TypedFML32 508 classes can respectively provide the functionalities of FML and FML32, and they can encapsulate the most frequently used and valuable FML and FML32 functions initially. The following steps can be applied to develop .NET applications using FML typed buffers:
1. Define FML field table files by compiling field table files into C# source files, which contain public classes including definitions of every FML field ID defined in the field table files.
2. Write the .NET application by using TypeFML class methods to create and access FML data.

In some embodiments, a natural way to invoke FML/FML32 functions on the instance can be to follow the OO styled calling convention to create an instance for each allocated typed buffer described above, i.e., in the form of obj.Method(, , ). In some other embodiments, composite functionalities based on the combination of the existing FML/FML32 functions can also be provided. For a non-limiting example, a FML function Fadd can be defined as:

int Fadd(FBFR *fbfr, FLDID fieldid, char *value, FLDLEN len)

Once this function is added to TypedFML class as a member method, its interface can be simplified as follows.
wherein the first parameter is omitted due to the fact that it is the instance itself so there is no need to specify it repeatedly. If more than one parameters of a function are specified a type of FBFR* or FBFR32* as its parameter type, the first can be treated as shown above, and the others can simply give place to a type of TypedFML 506 or TypedFML32 508 based on its corresponding types.

In some embodiments, the managed wrapper can use typed buffer class TypedVIEW 507 to create and access VIEW/VIEW32 data of Tuxedo to develop .NET applications via the following steps:
1. Define the VIEW definition file (.v).
2. Compile the VIEW definition file into a VIEW binary file (.VV).
3. Generate class TypedVIEW derived definition C# code and corresponding .dll library (if necessary) from the View binary file.
4. Write .NET application using class TypedVIEW.

In some embodiments, class TypedVIEW 507 can be used either with no environment variables or with .NET assembly environment variables to generate .dll libraries. The .NET assembly environment variables ASSFILES, ASSDIR (ASSFILES32, ASSDIR32 for view32) can be set accordingly in order to view the generated .dll libraries. Note that TypedView 507 can link to .dll libraries instead of C# code in the .NET environment because it can compile the class type into .dll libraries or .exe files. If the definition is compiled into both .dll libraries and .exe files, the output binaries for these two files can be different. Using these environment variables, .dll libraries can be generated either automatically or manually. In certain integrated programming environments (for non-limiting examples, VB .NET, and ASP.NET) it is best to manually generate .dll libraries as applications are integrated as .dll files.

Application Context and AppContext Class

In accordance with one embodiment of the present invention, the application environment descriptor can support application context 404.

Application context can be a very basic but important concept proposed to describe an application environment. Tuxedo client can join or leave an application (usually refers to user developed server) as well as invoking ATMI functions, based on the concept and implementation of application context.

In some embodiments, the managed wrapper integrates the concept of application context into the interfaces of its wrapper methods wherever a context is required, which simplifies the rules telling users in which context the current thread (process instead when there is no thread) is running. Such an approach can make the idea of application context more straightforward so that users can accurately understand it and easily use the API to program. In accordance to one embodiment of the present invention, class AppContext 404 can be defined to encapsulate ATMI functions based on one or more of the following rules:
1. Only those functions which logic indeed require an application context to be the operated object will be wrapped as a member method in class AppContext.
2. Some special functions provided for server side application do not need to be wrapped.
3. The return type of some ATMI functions is changed from an “int” to a “void” if those functions merely use the return value to indicate whether the execution succeeded or not.
   The AppContext 404 class can be a key class used to perform Tuxedo service access functions, which leverages the OO programming style in a multi-contexted client application.

In some embodiments, most Tuxedo ATMI C functions, for non-limiting examples, tpcall( ), and tpnotify( ), can be defined as AppContext class methods. Creating an AppContext class instance can be a key component in connecting to a Tuxedo domain and call services provided by that Tuxedo domain. Since creating a class AppContext instance can also create specific Tuxedo context instance, the managed wrapper does not require programmers to switch between different Tuxedo context using different ATMI functions in a multi-contexted application written in C or COBOL. In addition, operations on a particular AppContext will not impact other AppContext instances as a programmer can develop multi-context applications and easily switch between them. Note that Tuxedo context instances are not destroyed automatically and AppContext.tpterm( ) must be invoked before a Tuxedo context instance is destroyed.

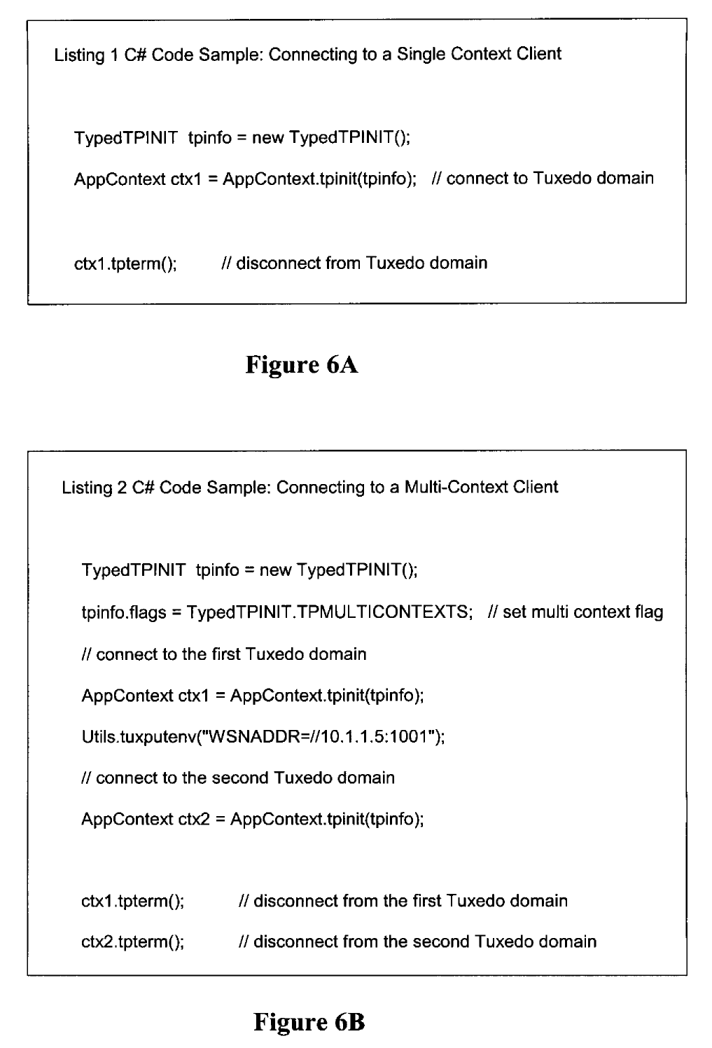

FIG. 6A is an exemplary C# Code Sample for connecting to a Single Context Client in accordance with one embodiment of the present invention.

FIG. 6B is an exemplary C# Code Sample for connecting to a Multi-Context Client in accordance with one embodiment of the present invention.

As shown in FIGS. 6A and 6B, the use of application context and explicitly referring to it in most ATMI functions can make users much inconvenient to implement a multi-context application especially when the operations of frequently switching context are needed.

In accordance with one embodiment of the present invention, the application context can manage the context switching implicitly when multiple contexts are used alternatively as shown in FIG. 6B.

Transaction Classes

In accordance with one embodiment of the present invention, the application context 404 can include one or more transaction instances 405.

In some embodiments, the managed wrapper encapsulates two set of transaction functions supported by Tuxedo so far, ATMI transaction 415a and TX transaction 415b, respectively into two transaction classes AtmiTransaction and TxTransaction to make the use of transaction functions clearer and simpler. Each instance of AtmiTransaction has a reference to an instance of AppContext, which is designed to realize the idea that AppContext represents the operating environment and AtmiTransaction represents the transactions taking place in it. They obey a multiple-to-one relationship, i.e., multiple instances of AtmiTransaction can be subject to a same instance of AppContext at the same time.

In some embodiments, the implicit context switching will be automatically performed when needed on behalf of current .NET thread while the methods of AtmiTransaction are called upon an instance of it. The mechanism is designed intentionally to avoid the redundant invocations on tpgetctxt and tpsetctxt so as to make the programs more concise. This can be done via executing the internal functionality provided by AppContext to assure that the instance of AppContext being operated by current .NET thread is associated with the very application context being performed by underlying native thread the Tuxedo libraries use.

Exceptions

One embodiment of the present invention further comprises an application error message handler 402.

In some embodiments, the managed wrapper adopts exception as the basic error handling mechanism since exception is one of error handling mechanisms being widely used in various modern OO languages such as C++, Java and C# and by the foundation class library of .NET. The wrapper classes can also follow the same rules as the foregoing to make users' programs written in a more concise and uniform style. The wrapper classes can map each value of tperror to a separate exception class so that the original manner of directly returning error codes can be transformed from ATMI functions into a new manner of throwing the exception associated with a specific error code from the methods of wrapper classes. Exceptions of wrapper classes can consist of two basic classes and two sets of derived classes originated from the ATMI error codes tperror and FML error code ferror.

One embodiment may be implemented using a conventional general purpose or a specialized digital computer or microprocessor(s) programmed according to the teachings of the present disclosure, as will be apparent to those skilled in the computer art. Appropriate software coding can readily be prepared by skilled programmers based on the teachings of the present disclosure, as will be apparent to those skilled in the software art. The invention may also be implemented by the preparation of integrated circuits or by interconnecting an appropriate network of conventional component circuits, as will be readily apparent to those skilled in the art.

One embodiment includes a computer program product which is a machine readable medium (media) having instructions stored thereon/in which can be used to program one or more computing devices to perform any of the features presented herein. The machine readable medium can include, but is not limited to, one or more types of disks including floppy disks, optical discs, DVD, CD-ROMs, micro drive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data. Stored on any one of the computer readable medium (media), the present invention includes software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, execution environments/containers, and applications.

The foregoing description of the preferred embodiments of the present invention has been provided for the purposes of illustration and description. It is not intended to be exhaustive or to limit the invention to the precise forms disclosed. Many modifications and variations will be apparent to the practitioner skilled in the art. Particularly, while the concept “wrapper”, “application”, “assembly”, and “builder” are used in the embodiments of the systems and methods described above, it will be evident that such concept can be interchangeably used with equivalent concepts such as, module, class, method, type, interface, bean, component, object, and other suitable concepts. Embodiments were chosen and described in order to best describe the principles of the invention and its practical application, thereby enabling others skilled in the art to understand the invention, the various embodiments and with various modifications that are suited to the particular use contemplated. It is intended that the scope of the invention be defined by the following claims and their equivalents.

What is claimed is:

1. A system to support managed wrapping of unmanaged distributed transaction functions for managed applications, comprising:
Wrapper Interfaces, the Wrapper Interfaces adapted to wrap around one or more unmanaged distributed transaction functions used by a managed application operable and further adapted to:
encapsulate one or more unmanaged distributed transaction libraries; and
provide connectivity between the one or more unmanaged distributed transaction libraries and the managed application; and
Wrapper Utilities operable to build the managed applications using the Wrapper Interfaces, wherein the managed applications are operable to invoke the one or more unmanaged distributed transaction libraries through Wrapper Interfaces to run under managed environment.

2. The system according to claim 1, wherein:
the Wrapper Interfaces are object-oriented-styled.

3. The system according to claim 2, wherein:
the Wrapper Interfaces are contained in one or more managed libraries such as .Net assembly libraries.

4. The system according to claim 2, wherein:
the Wrapper Interfaces operable to:
mirror the underlying one or more unmanaged distributed transaction libraries; and
convert between managed and unmanaged data types.

5. The system according to claim 2, wherein:
the Wrapper Interfaces wrap around unmanaged distributed transaction functions including Tuxedo ATMI functions and FML functions.

6. The system according to claim 2, wherein:
the Wrapper Interfaces are operable to inform the managed application one or more of:
name of a unmanaged distributed transaction function to be called;
name of Dynamically Linked Library (DLL) that contains the function; and
how to marshal the function's one or more parameters.

7. The system according to claim 2, wherein:
the Wrapper Interfaces are operable to support typed buffer.

8. The system according to claim 7, wherein:
the typed buffer is one of: FML, FML32, VIEW, VIEW32, CARRAY, and STRING.

9. The system according to claim 1, wherein:
the Wrapper Interfaces are operable to support application context.

10. The system according to claim 2, wherein:
the Wrapper Interfaces are operable to encapsulate multiple sets of unmanaged distributed transaction functions.

11. The system according to claim 2, wherein:
the Wrapper Interfaces are operable to encapsulate a composite data structure for the use of high precision computation.

12. The system according to claim 2, wherein:
the Wrapper Interfaces are operable to adopt exception as the basic error handling mechanism.

13. The system according to claim 1, wherein:
the Wrapper Utilities are operable to build the managed applications by referencing the Wrapper Interfaces at runtime.

14. The system according to claim 13, wherein:
the Wrapper Utilities include one or more of:
.Net client builder;
View/View32 class generator from input View description file; and
Field Definition class generator from input Field definition file.

15. A method to support managed wrapping of unmanaged distributed transaction functions for managed applications, comprising:
using Wrapper Interfaces for a managed programming language, wherein the Wrapper Interfaces are operable to:
encapsulate one or more unmanaged distributed transaction libraries; and
provide connectivity between the one or more unmanaged distributed transaction libraries and a managed application; and
building the managed application by referring to the Wrapper Interfaces to allow the managed application to access the one or more unmanaged distributed transaction libraries at runtime.

16. The method according to claim 15, further comprising one or more of:
invoking the managed Wrapper under managed environment to access the one or more unmanaged distributed transaction libraries at runtime.

17. The method according to claim 15, further comprising:
informing the .NET application one or more of:
name of a unmanaged distributed transaction function to be called;
name of Dynamically Linked Library (DLL) that contains the function; and
how to marshal the function's one or more parameters.

18. The method according to claim 15, further comprising one or more steps of:
supporting typed buffer and/or application context;
encapsulating a composite data structure for the use of high precision computation; and
adopting exception as the basic error handling mechanism.

19. The method according to claim 15, further comprising one or more steps of:
generating View/View32 class from input View description file;
generating FML FLDID class from input Field definition file; and
building .Net client.

20. A system to support managed wrapping of unmanaged distributed transaction functions for managed applications, comprising:
an abstract interface to manipulate distributed transaction messages without the need to consider implementation details of the distributed transaction messages; and
an application environment descriptor representing an unmanaged distributed transaction application environment.

21. The system according to claim 20, wherein:
the abstract interface is operable to support typed buffer.

22. The system according to claim 21, wherein:
the typed buffer is not allowed to be created directly.

23. The system according to claim 21, wherein:
the typed buffer is one of: FML, FML32, VIEW, VIEW32, CARRAY, and STRING.

24. The system according to claim 20, wherein:
the application environment descriptor is operable to support application context.

25. The system according to claim 24, wherein:
the application context is operable to manage the context switching implicitly when multiple contexts are used alternatively.

26. The system according to claim 24, wherein:
the application context includes one or more transaction instances.

27. The system according to claim 26, wherein:
the transaction instances include ATMI transactions and TX transactions.

28. The system according to claim 20, further comprising:
an application error message handler.

29. A method to support managed wrapping of unmanaged distributed transaction functions for managed applications, comprising:
providing the users an abstract interface to manipulate distributed transaction messages without the need to consider implementation details of the distributed transaction messages; and
representing an unmanaged distributed transaction application environment with a managed distributed transaction application environment descriptor.

30. The method according to claim 29, wherein:
the abstract interface to manipulate distributed transaction messages is operable to support typed buffer.

31. The method according to claim 30, wherein:
the typed buffer is not allowed to be created directly.

32. The method according to claim 31, wherein:
the typed buffer is one of: FML, FML32, VIEW, VIEW32, CARRAY, and STRING.

33. The method according to claim 29, wherein:
the application environment descriptor is application context.

34. The method according to claim 33, wherein:
the application context includes one or more transaction instances

35. The method according to claim 33, further comprising:
switching context implicitly when multiple context are used alternatively.

36. The method according to claim 33, further comprising:
managing the one or more unmanaged distributed transaction at runtime under managed environment.

37. The method according to claim 29, further comprising:
handling application errors messages.

38. A machine readable medium having instructions stored thereon that when executed cause a system to:
create Wrapper Interfaces for a managed programming language, wherein the Wrapper Interfaces are operable to:
encapsulate one or more unmanaged distributed transaction libraries; and
provide connectivity between the one or more unmanaged distributed transaction libraries and a managed application; and
build the managed application by referring to the Wrapper Interfaces to allow the managed application to access the one or more unmanaged distributed transaction libraries at runtime

39. A machine readable medium having instructions stored thereon that when executed cause a system to:
provide the users an abstract interface to manipulate distributed transaction messages without the need to consider implementation details of the distributed transaction messages; and
represent an unmanaged distributed transaction application environment with a managed distributed transaction application environment descriptor.

40. A system to support managed wrapping of Tuxedo functions for .NET applications, comprising:
Wrapper Interfaces, the Wrapper Interfaces adapted to wrap around one or more Tuxedo functions used by a .NET application operable and further adapted to:
encapsulate one or more unmanaged Tuxedo libraries; and
provide connectivity between the one or more unmanaged Tuxedo libraries and the .NET application; and
Wrapper Utilities operable to build .NET applications using the Wrapper Interfaces, wherein the .NET applications are operable to invoke the one or more unmanaged Tuxedo libraries through Wrapper Interfaces to run under Common Language Runtime (CLR).
